(19) United States
(12) Patent Application Publication
(10) Pub. No.: US 2009/0126581 A1
(43) Pub. Date: May 21, 2009

(54) Dispenser system using gas injection

(75) Inventors: Cornelis Margaretha Theodorus Maria Bongers, Helmond (NL); Stephan Rein, Rotterdam (NL)

Correspondence Address: SUGHRUE MION, PLLC, 2100 PENNSYLVANIA AVENUE, N.W., SUITE 800, WASHINGTON, DC, 20037, US

(73) Assignee: Friesland Brands B.V., Meppel (NL)

(21) Appl. No.: 11/915,040

(22) PCT Filed: May 24, 2006
(86) PCT No.: PCT/NL06/50124

§ 371 Date: Jun. 16, 2008

(30) Foreign Application Priority Data
May 25, 2005 (NL) 1029124

(51) Int. Cl. A23G 1/10; B67D 5/58

(52) U.S. Cl. 99/485; 222/190

(57) ABSTRACT

Dispenser system for dispensing a liquid product, in which a container containing a bag (20), containing therein the liquid product, can be placed in the dispenser system. The dispenser system (15) includes a gas injection element (9) that can be connected to the bag (20) for homogenising the liquid product in the bag (20). The dispenser system (15) further comprises a control unit (1) that is equipped to activate the gas injection element (9) depending on the product present in the bag (20). The container with bag (20) can have an identification element (21), containing data that are important for the operation of the dispenser system (15).

### FIELD OF THE INVENTION

The present invention relates to a dispenser system for dispensing a liquid product, for example a metering system or drinks machine, in which a container containing a bag, containing therein the liquid product, can be placed.

### PRIOR ART

European Patent Application EP-A 1 132 333 discloses a system that makes use of a flexible bag containing therein a liquid product, wherein small amounts of the product can be dispensed in a simple manner. A flexible hose is inserted into the flexible bag and a specific amount of product is drawn out of the bag with the aid of a (vacuum) pump, for example for serving a drink.

A drawback of this known system (also known as a ‘bag-in-box’) is that it is only suitable for specific types of liquid products. Liquid products that have to be shaken before use (such as fruit juices containing fruit pulp) cannot be used in a system of this type, because particles of the product in the bag sink and the product cannot be dispensed as a homogeneous product.

### SUMMARY OF THE INVENTION

The present invention seeks to provide a dispenser system that is suitable for use with liquid products which lose their homogeneity under the influence of gravity and have to be shaken before use.

According to the present invention a dispenser system according to the type defined in the preamble is provided, wherein the dispenser system includes a gas injection element that can be connected to the bag for homogenising the liquid product in the bag. By injecting gas into the container with bag, turbulent eddying is caused in the liquid product owing to the formation of tiny bubbles, as a result of which the descending particles are redistributed throughout the liquid product.

It should be noted that an assembly consisting of a container containing therein a bag containing a liquid product (‘bag-in-container’) is known from International Patent Application WO 01/44072. The system described in this publication provides a solution for counteracting the loss in shape of a bag in a container during transportation of the bag in the container. The loss in shape can cause damage in the bag and therefore loss or contamination of the product in the bag. According to this publication, this problem is solved by applying a vacuum in the space between container and bag, or by injecting gas into the bag, so that the bag and container fit properly at all times. However, this publication does not disclose any measures concerning the homogenisation of the liquid product by means of gas injection.

In a further embodiment the dispenser system includes a control unit that is equipped to activate the gas injection element depending on the product present in the bag. The control unit can be equipped to produce an injection of gas with a predetermined amount of gas after initial placement of the bag in the dispenser system. Furthermore, the control unit can be equipped to produce an injection of gas with a predetermined amount of gas before dispensing of the liquid product from the dispenser system. In this way it can be ensured that the product is sufficiently ‘shaken’ before a portion is served, so that a homogeneous product can be served.

In a further embodiment the dispenser system further comprises a pressure sensor that is connected to the control unit, wherein the control unit is equipped to maintain the pressure in the bag containing liquid product at a predetermined level. This makes it possible for the liquid product, for example a viscous liquid such as whipped cream, to be dispensed under pressure.

In a further embodiment the dispenser system includes a temperature-regulating element that is connected to the control unit for controlling the temperature of the product in the bag, wherein the control unit is further equipped for activating the temperature-regulating element on the basis of the product data. The temperature-regulating element can, for example, be a cooling installation or a heating installation, or a combination of both, depending on the product to be served. With this installation the product can be brought to an appropriate temperature, both for storing in the dispenser system and for serving. The combination with the abovementioned gas injection results in even better heating/cooling of any product in the container with bag. The dispenser system can further comprise a temperature sensor connected to the control unit for sensing the temperature of the liquid product in the bag. Coupled regulation of the temperature of the product is thus facilitated.

In a further aspect the dispenser system further comprises a reader connected to the control unit for reading an identification element on the bag. The identification element can be a (one-dimensional or two-dimensional, single or multiple) barcode or, for example, a radio frequency identification label (RFID tag). The identification element contains product data and the control unit is further equipped for activating the gas injection element on the basis of the product data.

Using the reader, e.g. the reader may be configured for locking the dispenser system if an identification code contained in the data does not correspond to a group of permissible identification codes. With this method of authentication it is possible to check whether a specific bag and container do in fact originate from the specified supplier. This is necessary, for example, in connection with legislation in the field of monitoring and tracing food products, but also, for example, in connection with the active managing of the use-by date.

In a further embodiment the product data further comprises an (intrinsic) expiration date. The control unit is further equipped for issuing a warning signal (for example, to a display) if the expiration date has elapsed. The check can take place both during initial placement of the container with bag and continuously during the use of the dispenser system. In a further embodiment the control unit is further equipped for the continuous recalculation of a use-by date, depending on associated data such as the expiration date, the date on which the bag was opened, the temperature history, etc., and for issuing a warning signal (for example, to a display) if the use-by date has elapsed.

In yet a further embodiment the product data further comprises a maximum permissible pressure in the bag and the dispenser system further comprises a pressure sensor connected to the control unit. The control unit is, in this case, equipped to activate the gas injection element with due regard for the maximum permissible pressure. This makes it possible to serve portions of the product also under pressure, instead of just using gravity, which is advantageous for serving viscous products.

The product data can further comprise one or more details from the group consisting of:
a verification key (to be used for verification in combination with the above-mentioned identification code);
maximum permissible temperature; shelf life after opening (important for operating the dispenser system);
product settling characteristics; thermal conductivity characteristics; initial mixing instructions; maintenance mixing instructions (important for the control of the gas injection in the dispenser system);
product viscosity; product acidity; thermal conductivity characteristics (also important for operational use of the dispenser system).

### BRIEF DESCRIPTION OF THE DRAWINGS

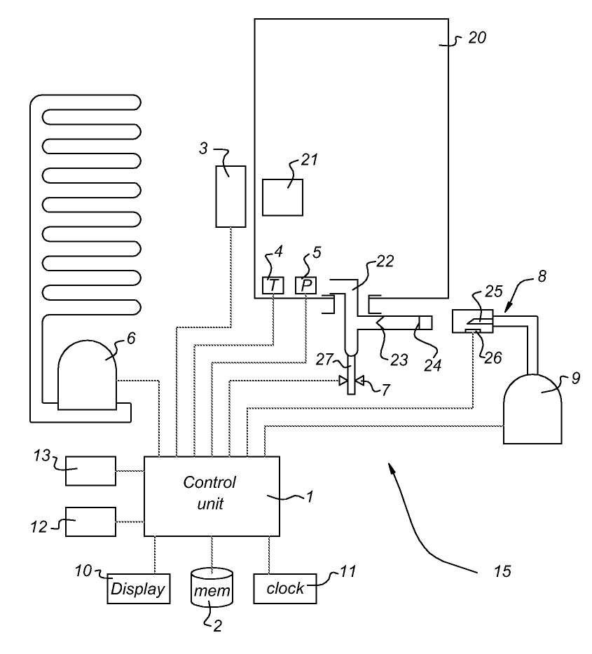

The present invention will now be discussed in more detail on the basis of a number of illustrative embodiments, with reference to the appended drawings, in which FIG. 1 shows a diagrammatic representation of a dispenser system in which the present invention is employed.

### DETAILED DESCRIPTION OF ILLUSTRATIVE EMBODIMENTS

The present invention can advantageously be employed in drinks machines, dispenser systems and the like, which distribute a liquid product, the homogeneity of which can decrease under the influence of gravity. Examples of liquid products of this type are fruit drinks, in particular those containing fruit pulp, and yoghurt drinks or chocolate milk (these drinks contain protein particles and other particles that are dispersed in liquid). However, the present invention is also advantageously applicable for viscous liquids such as whipped cream or tomato purée.

FIG. 1 is a simplified diagrammatic representation of an embodiment of a dispenser system 15 in which the present invention is employed. The dispenser system 15 has a control unit 1, connected to a memory device 2 and a (battery-powered) clock 11. The control unit 1 with the associated memory device 2 and clock 11 can, for example, be made up of a computer system containing a central processing unit and semiconductor or magnetic memory. The entire system can be made as an industrial control unit.

The dispenser system 15 is generally accommodated in a case and comprises a container with bag 20 (‘bag-in-box’) containing therein the liquid product to be distributed. A connector 22 is fitted at the bottom of the container with bag 20, the connector 22 having a flexible tube 27 on which a corresponding clamping device 7 can be placed in the dispenser system 15. The clamping device 7 is controlled by the control unit 1 in order to dispense portions of the liquid product, for example by operating a dispenser button 12 connected to the control unit 1.

The dispenser system 15 further comprises a temperature-regulating unit 6, for example a cooling installation and/or a heating installation, which is also controlled by the control unit 1. Furthermore, the control unit 1 is connected to a case switch 13, which indicates whether the case of the dispenser system 15 is closed and therefore ready for use. A display 10, connected to the control unit 1, can be used to reproduce information for a user or a maintenance engineer for the dispenser system 15.

For operational use of the dispenser system 15, the control unit 1 is also connected to one or more sensors which record current characteristics of the liquid product in the bag 20, for example the temperature sensor 4 and pressure sensor 5 shown in FIG. 1. The sensors 4, 5 can be positioned in the dispenser system 15 in such a way that they are in contact with the container with bag 20, when this has been correctly positioned, in order thus to be able to measure the correct data.

The embodiment shown in FIG. 1 also contains a gas injection element consisting of a pressure generator 9 and a gas connector 8. The pressure generator 9 can, for example, comprise a compressor for compressing air, which is controlled by the control unit 1. Alternatively, the pressure generator 9 can comprise an accumulator in which a gas is stored under pressure, or a combination of compressor and accumulator. Gases other than air, such as nitrogen or carbon dioxide, can also be used. The gas connector 8 is shaped in such a way that this can only be connected to the appropriate end of the connector 22 of the bag 20 if the bag 20 is positioned correctly in the dispenser system 15. The gas connector 8 can, for example, have a key-shaped part that fits on the connector 22 precisely when the container with bag 20 has been placed in the correct physical location in the dispenser system 15.

The connector 22 is provided with a valve element 23 and a membrane 24, and the gas connector 8 is provided with a hollow needle 25. When the gas connector 8 is put on the connector 2, the hollow needle 25 perforates the membrane 24. The valve element 23 (made, for example, from silicone material) prevents liquid product from being able to flow out of the connector 22 towards the gas connector 8. Correct positioning of the gas detector 8 on the connector 22 is detected by a micro switch 26 in the gas connector 8, which, in turn, is connected to the control unit 1.

The gas generator 9 is able to inject gas in a controlled manner into the container with bag 20 via the gas connector 8 and connector 22. As a result of this, particles from the liquid product, which fall to the bottom of the container with bag 20 under the influence of gravity, are rehomogenised throughout the liquid product owing to the turbulence of gas bubbles. As an associated advantage, the temperature distribution of the liquid product in the container with bag 20 is also homogenised.

The container with bag 20 is further provided with an identification element 21, such as a (one-dimensional or two-dimensional) barcode. This identification element 21 contains data concerning said container with bag 20 and the content thereof, which can be read by a reader 3 that is connected to the control unit 1. In an alternative embodiment, the container with bag 20 can be produced with several (for example, one-dimensional) barcodes 21, which can be read in series with the aid of the reader 3. Several one-dimensional barcodes 21 can contain just as much information as a two-dimensional barcode 21. The advantage, in this case, is that a simpler and less expensive reader 3 can suffice. Once the case of the dispenser system 15 has been closed (as detected by case switch 13), the reader 3 is activated by the control unit 1 to read the data from the identification element 21. With the aid of, for example, a control sum (as part of the data), the control unit is able to verify whether the data received have been read correctly by the reader 3.

The data can contain, for example, an identification number, possibly in combination with a verification key, so as to be able to verify that the container with bag 20 did in fact come from a particular supplier. This enables monitoring and tracing of the container with bag 20.

In an alternative embodiment the identification element 21 and reader 3 are in the form of a radio frequency identification label (RFID) and an associated reader.

The data on the identification element 21 can include details relating to characteristics of the liquid product in the container with bag 20, such as an (intrinsic) shelf-life expiration date, maximum storage temperature and shelf life after opening. The control unit 1 is configured to check, when a specific container with bag 20 is put into service, that the expiration date has not yet been exceeded.

On the basis of the identification number, the control unit 1 is also able to check, with reference to a stored list of permitted identification numbers (or permitted types, if a part of the identification number indicates a type of container with bag 20 and contents), whether the container with bag 20 in question is suitable for use in the dispenser system 15. Alternatively, this check can also take place via a network, for example the Internet, by a centrally installed control unit. The entire identification procedure can then also be used as an electronic indication of first user.

It should be noted that the combination of identification element 21 and reader 3 can also advantageously be employed per se in a dispenser system, in particular even without the use of gas injection.

For effective functioning of the gas injection means (shaking before use), characteristic properties of the liquid product in the container with bag 20 must, of course, be taken into account. The data on the identification element therefore includes specific details such as:
product deposition characteristics, for example the time taken for 10% of the particles in the liquid to settle on the bottom of the container with bag 20;
product viscosity;
thermal conductivity characteristics of the product;
maximum permissible pressure in the container with bag 20;
start-up mixing instructions (gas injection pressure, duration of gas injection and cycles, for example as a function of the length of time between production and placement of the container with bag 20 in the dispenser system);
maintenance mixing instructions (again, gas injection pressure, duration of gas injection and cycles).

When a container with bag 20 is initially put into service in the dispenser system 15, the control unit 1 calculates start-up mixing instructions or a start-up programme on the basis of various details such as the product deposition characteristics, product viscosity, how far the product is into its lifespan, etc. The product in the container with bag 20 is cooled or heated with the aid of the temperature-regulating unit 6 to the prescribed storage/serving temperature. The particles (which may have settled) in the liquid product are remixed with the aid of gas injection. The gas bubbles cause volume displacements of the liquid product, resulting in turbulence and homogenisation (both particles in the liquid product and the temperature distribution). In order to facilitate the gas injection, the container with bag 20 is not completely filled with liquid product, so that the gas injection does not lead to an appreciable increase in pressure in the container with bag 20. An pressure relief valve may optionally be provided in the container with bag 20. By using information from the temperature sensor 4, the control unit 1 is able to activate the temperature-regulating unit 6 in a closed-loop control circuit. The variation in temperature of the product over time can be stored by the control unit 1 in the memory 2 and used later, for example for quality assurance, or further calculations regarding the actual shelf life of the product.

During normal use, the control unit 1 regulates, with the aid of the clamping device 7, the amount of product that is served. This can either be a continuous serving setting (product is supplied for as long as the serving button 12 is depressed) or be a preset volume (precise amount is dispensed after the serving button 12 has been depressed). In the latter case, the control unit 1 can be configured to calculate, on the basis of known data (pressure, temperature, viscosity), a serving time after which a flow of product has reached the preset volume. The control unit 1 can also be configured to interrupt the product flow immediately as soon as the serving button 12 is depressed a second time.

The control unit 1 is further configured to ‘shake’ the liquid product in the container with bag 20 intermittently with the aid of a gas injection means in accordance with the maintenance mixing instructions (or maintenance programme). A fixed, prescribed maintenance programme (as obtained via the reader 3 for the identification element 21) can be used for this purpose. Alternatively, in addition to this prescribed maintenance programme, various details, such as product deposition characteristics, the product viscosity, the build-up of pressure in the container with bag 20 and the time since the most recent homogenisation, are included in calculations in order to adjust the maintenance programme, if necessary. The gas injection associated with the maintenance programme can take place periodically or, for example, occur prior to each supply of a portion. In the latter case, the actual dispensing of the liquid product can, for example, be delayed by one second after operation of the serving button 12.

The present dispenser system 15 can also be used advantageously to serve viscous products. By means of the pressure generator 9, the product in the container with bag 20 can be pressurised in a controlled manner. As a result of this, the product can be served at a higher flow rate than is possible by means of gravity alone.

In a further embodiment the control unit 1 can be equipped to calculate the remaining shelf life of the product in the container with bag 20. During use, the intrinsic expiration date of the product is, in any case, monitored continuously and, once it has been exceeded, a warning can be presented on the display 10. The use-by date or remaining shelf life can be continuously recalculated on the basis of the length of time since the container with bag 20 was put into service, the storage temperature and, for example, the acidity (pH value) of the product. Once the use-by date has been exceeded, a warning is generated on the display 10 and the clamping device 7 is barred so that no further product may be served. As a result of the checking of the identity of the container with bag 20, removal of the container with bag 20 and immediate repositioning thereof will not reset the system, and will still bar distribution of the product from the bag in question.

The present invention has been described in detail in the above description of the drawings with reference to an illustrative embodiment. It will be clear to a person skilled in the art that modifications and alterations are possible, for example in the connection of the pressure generator 9 to the container with bag 20, which are also considered to fall within the scope of protection of this patent application, as defined by the appended claims.

1. Dispenser system for dispensing a liquid product, in which a container containing a bag (20), containing therein the liquid product, can be placed, characterised in that the dispenser system (15) includes a gas injection element (9) that can be connected to the bag (20) for homogenising the liquid product in the bag (20).

2. Dispenser system according to claim 1, wherein the dispenser system (15) includes a control unit (1) that is equipped to activate the gas injection element (9) depending on the product present in the bag (20).

3. Dispenser system according to claim 2, wherein the control unit (1) is equipped to produce an injection of gas with a predetermined amount of gas after initial placement of the bag (20) in the dispenser system (15).

4. Dispenser system according to claim 2, wherein the control unit (1) is further equipped to produce an injection of gas with a predetermined amount of gas before dispensing of the liquid product from the dispenser system (15).

5. Dispenser system according to claim 2, further comprising a pressure sensor (5) that is connected to the control unit (1), wherein the control unit (1) is equipped to maintain the pressure in the bag (20) containing liquid product at a predetermined level.

6. Dispenser system according to claim 2, further comprising a temperature-regulating element (6) that is connected to the control unit (1) for controlling the temperature of the product in the bag (20), wherein the control unit (1) is further equipped for activating the temperature-regulating element (6) on the basis of the product data.

7. Dispenser system according to claim 2, further comprising a temperature sensor (4) connected to the control unit (1) for sensing the temperature of the liquid product in the bag (20).

8. Dispenser system according to claim 2, further comprising a reader (3) connected to the control unit (1) for reading an identification element (21) on the bag (20), wherein the identification element (21) contains product data and wherein the control unit (1) is further equipped for activating the gas injection element (9) on the basis of the product data.

9. Dispenser system according to claim 8, wherein the product data comprises an identification code and the control unit (1) is equipped for locking the dispenser system (15) if the identification code does not correspond to a group of permissible identification codes.

10. Dispenser system according to claim 8, wherein the product data further comprises an expiration date and wherein the control unit (1) is further equipped for issuing a warning signal if the expiration date has elapsed.

11. Dispenser system according to claim 8, wherein the control unit (1) is further equipped for the continuous recalculation of a use-by date, depending on associated data such as the expiration date, the date on which the bag was opened, the temperature history, etc., and for issuing a warning signal if the use-by date has elapsed.

12. Dispenser system according to claim 8, wherein the product data further comprises a maximum permissible pressure in the bag (20), the dispenser system (15) further comprises a pressure sensor (5) connected to the control unit (1) and the control unit (1) is further equipped to activate the gas injection element (9) with due regard for the maximum permissible pressure.

13. Dispenser system according to claim 8, wherein the product data further comprises one or more details from the group consisting of: a verification key; maximum permissible temperature; shelf life after opening; product settling characteristics; thermal conductivity characteristics; initial mixing instructions; maintenance mixing instructions; product viscosity; product acidity; thermal conductivity characteristics.
